(19) United States
(12) Patent Application Publication
(10) Pub. No.: US 2022/0304247 A1
(43) Pub. Date: Sep. 29, 2022

(54) PLANTER BOX

(71) Applicants: Brook Nolin, Dickens, IA (US); Karl W. Nolin, Spencer, IA (US)

(72) Inventors: Brook Nolin, Dickens, IA (US); Karl W. Nolin, Spencer, IA (US)

(21) Appl. No.: 17/705,975

(22) Filed: Mar. 28, 2022

Related U.S. Application Data
(60) Provisional application No. 63/166,575, filed on Mar. 26, 2021.

(51) Int. Cl. A01G 9/02; G09F 13/04; G09F 23/00

(52) U.S. Cl. CPC A01G 9/02; G09F 13/0413; G09F 23/00

(57) ABSTRACT

A system and method for flexibly displaying information from interchangeable faceplates located on a planter box, a wall mounted display and a yard mounted display, where a single NC file is used to define the visual appearance of each of said faceplates.

### CROSS REFERENCE TO RELATED APPLICATIONS

This application claims the benefit of a provisional application filed on Mar. 26, 2021, and having Ser. No. 63/166,575 entitled “PLANTER BOX” which is hereby incorporated herein in its entirety by this reference.

### FIELD OF THE INVENTION

The present invention generally relates to interchangeable faceplates of plant stand holder, plant stand box, and, even more particularly, relates to removable face plates also can be mounted to yard stake mount or wall hang mount.

### BACKGROUND OF THE INVENTION

In the past, planter boxes have been often been made with custom decorative sides.

While these planter boxes have enjoyed much success in various locations and orientations and have been used extensively in the past, they are capable of improvement.

Consequently, there exists a need for improved methods and systems for displaying custom information in a variety of locations which include planter boxes.

### SUMMARY OF THE INVENTION

It is an object of one aspect of the present invention to provide a flexible system of various locations for displaying custom information.

It is a feature of one aspect of the present invention to utilize an interchangeable face plate.

It is an advantage of the present invention to provide for the system to be flexible over time. In that, the faceplate can be replaced seasonally, or depending upon current events.

It is additional feature of the present invention to provide a back light behind the interchangeable faceplate.

It is an additional advantage of this embodiment of the present invention to make the custom information more noticeable in low light conditions.

Accordingly, the present invention is:

A system comprising:

A planter box having a first backlighted laser cut powder coated steel faceplate, with a first portion of steel having been removed therefrom;

A wall mounted display having a second backlighted laser cut powder coated steel faceplate, with a second portion of steel having been removed therefrom;

A yard display having a third backlighted laser cut powder coated steel faceplate with a third portion of steel having been removed therefrom;

said first backlighted laser cut powder coated steel faceplate, said second backlighted laser cut powder coated steel faceplate, and said third backlighted laser cut powder coated steel faceplate are each configured so as to be interchangeable with each other; and,

each of said first portion, said second portion, and said third portion being individually and identically defined by a common data file.

Additionally the present invention is a method of displaying information from a system including a planter box, a wall mounted display and a yard display supported by yard stakes;

the method comprising the steps of:

providing a planter box having a first backlighted laser cut powder coated steel faceplate, with a first portion of steel having been removed therefrom;

providing a wall mounted display having a second backlighted laser cut powder coated steel faceplate, with a second portion of steel having been removed therefrom;

providing a yard display having a third backlighted laser cut powder coated steel faceplate with a third portion of steel having been removed therefrom;

said first backlighted laser cut powder coated steel faceplate, said second backlighted laser cut powder coated steel faceplate, and said third backlighted laser cut powder coated steel faceplate are each configured so as to be interchangeable with each other; and,

defining each of said first portion, said second portion, and said third portion by utilizing a common data file.

Lastly the present invention is a system comprising:

A planter box having a first backlighted laser cut powder coated steel faceplate, with a first portion of steel having been removed therefrom;

A wall mounted display having a second backlighted laser cut powder coated steel faceplate, with a second portion of steel having been removed therefrom;

A yard display having a third backlighted laser cut powder coated steel faceplate with a third portion of steel having been removed therefrom;

said first backlighted laser cut powder coated steel faceplate, said second backlighted laser cut powder coated steel faceplate, and said third backlighted laser cut powder coated steel faceplate are each configured so as to be interchangeable with each other; and,

each of said first portion, said second portion, and said third portion being defined by a data file.

### BRIEF DESCRIPTION OF THE DRAWINGS

FIG. 1 is a perspective view of a planter box of the present invention.

FIG. 2 is a perspective view of the planter box of FIG. 1 with portions removed to expose underlying details.

FIG. 3 is perspective view of a portion of the planter box of FIG. 1.

FIG. 4 is an alternate view of an interchangeable face plate of FIG. 1.

FIG. 5 is a perspective view of a wall mount system of the present invention.

FIG. 6 is a perspective view of a yard system of the present invention.

FIG. 7 is a perspective view of a pair of yard stakes of FIG. 6.

FIG. 8 is a simplified perspective view of the system of the present invention.

### DETAILED DESCRIPTION

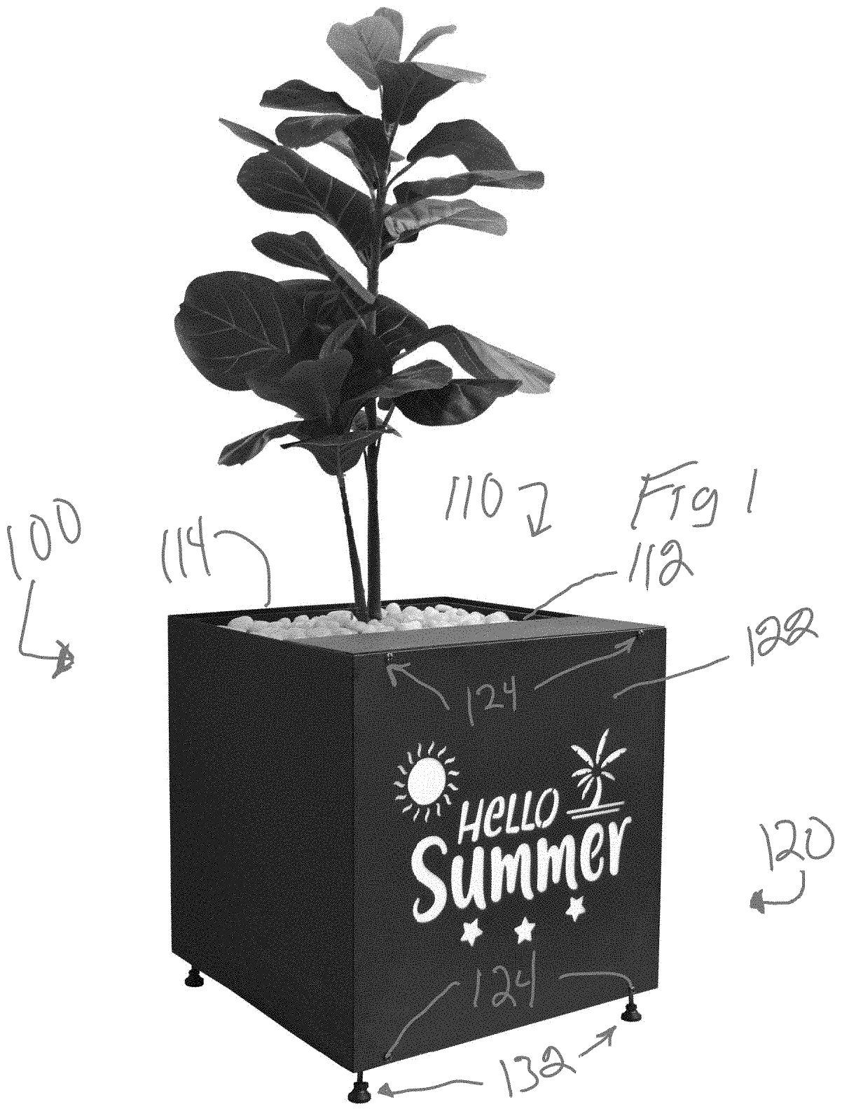

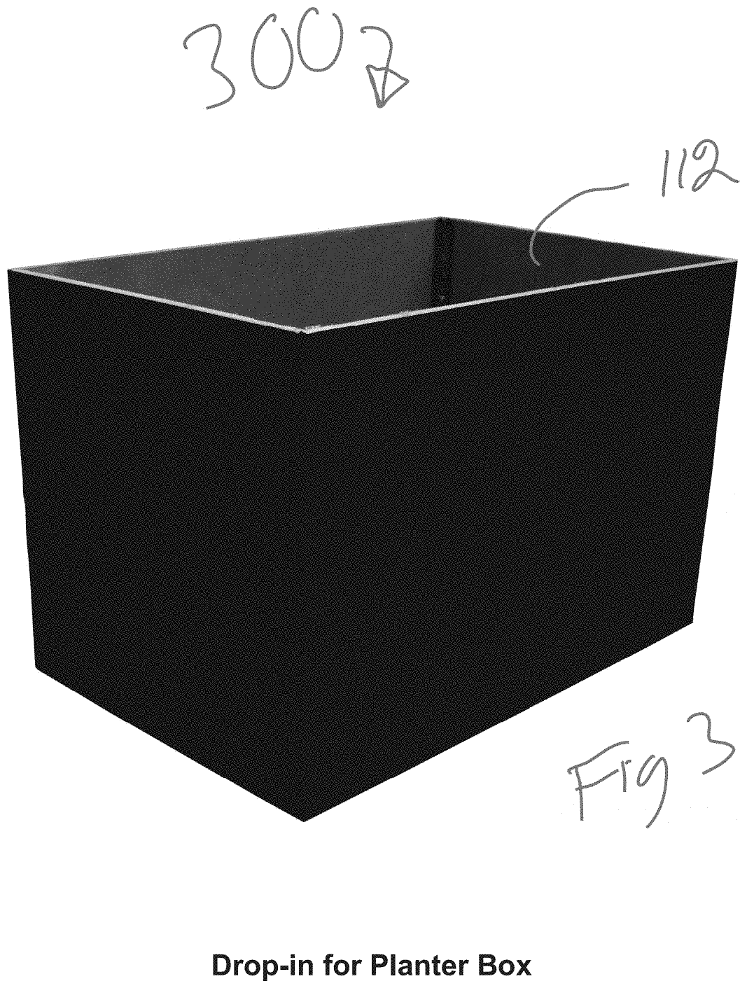

Now referring to the drawings wherein like numerals refer to like matter throughout and more particularly referring to FIG. 1, which is a complete planter box 100 of the present invention, having a top end 110, and an internal drop in face 112 of the drop in 300 of FIG. 3, a internal planter box face 114, an interchangeable faceplate 122 with a custom image cut therein. Faceplate 122 is shown held by screws 124. The planter box 100 is shown with feet 132.

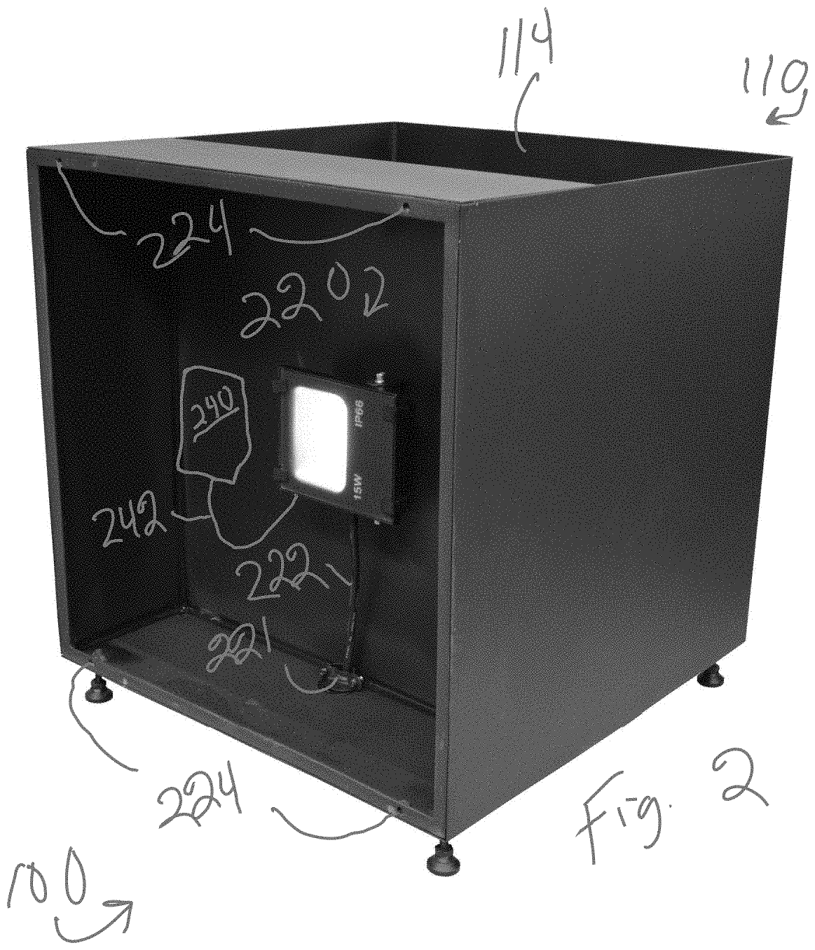

Now referring to FIG. 2, there is shown a view of the planter box of FIG. 1 with the faceplate 122 and the drop in 300 of FIG. 3, having been removed. Internal planter box face 114 is more exposed and shown to a larger extent than FIG. 1. Screw receiving holes 224 are shown as well as backlight 220 and associated power cord 222 which is retained at a point of exit from the planter box 100 by cord holder 221. The power cord 112 could be replaced in an alternative design with a battery assembly 240 which may include a battery, a wireless communication system, a control system and associated electronics for selectively controlling the back light 220 via a control/power line 242.

Now referring to FIG. 3, there is shown a plastic drop in insert 300 with an internal face 112. Insert 300 may have a hole centered in the bottom portion and a removable rubber drain plug disposed in the hole. This hole allows for drainage of water. If the system is being used indoors there may be a water catch tray below the hole to capture water existing through the hole.

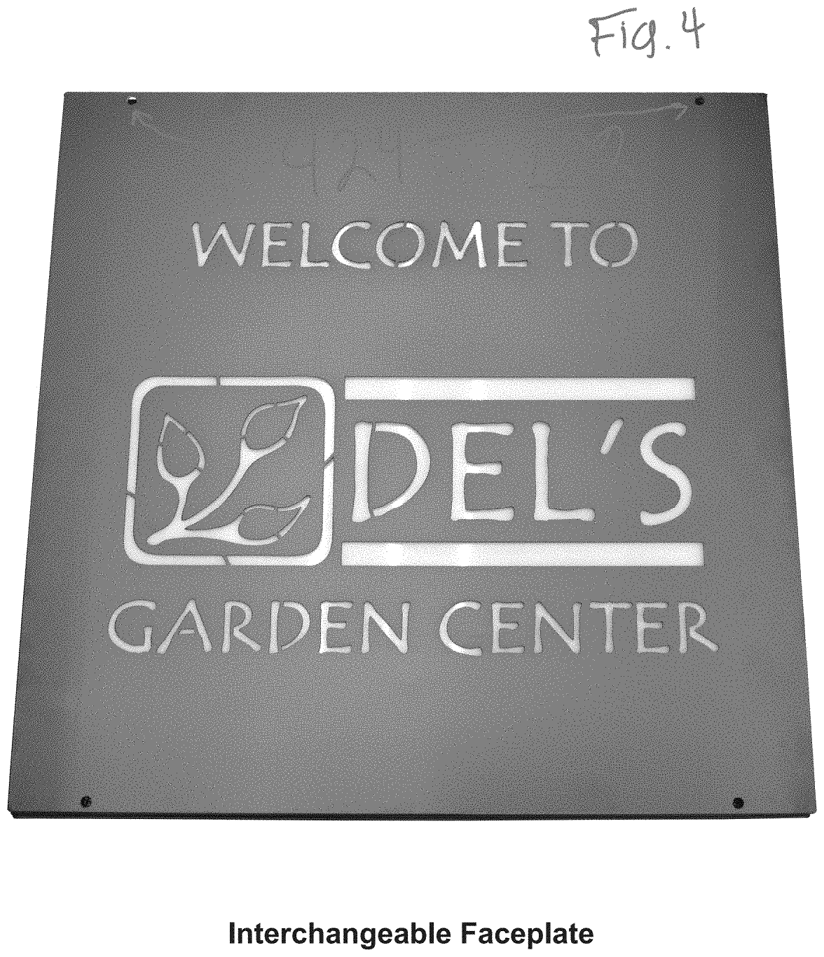

Now referring to FIG. 4, there is shown an alternative design on the interchangeable faceplate 122. In this view the passage holes 424 for allowing screws 124 to pass through are shown open and empty. We take a design that is wanted to be cut on the faceplate. For a faceplate of 18″×18″ we have a designed area of approximately 16″×16″. The artwork must fit into the area. The artwork has to be reviewed for laser cutting. An NC file is created of the design. This file is then read by the laser—thus cutting out the design.

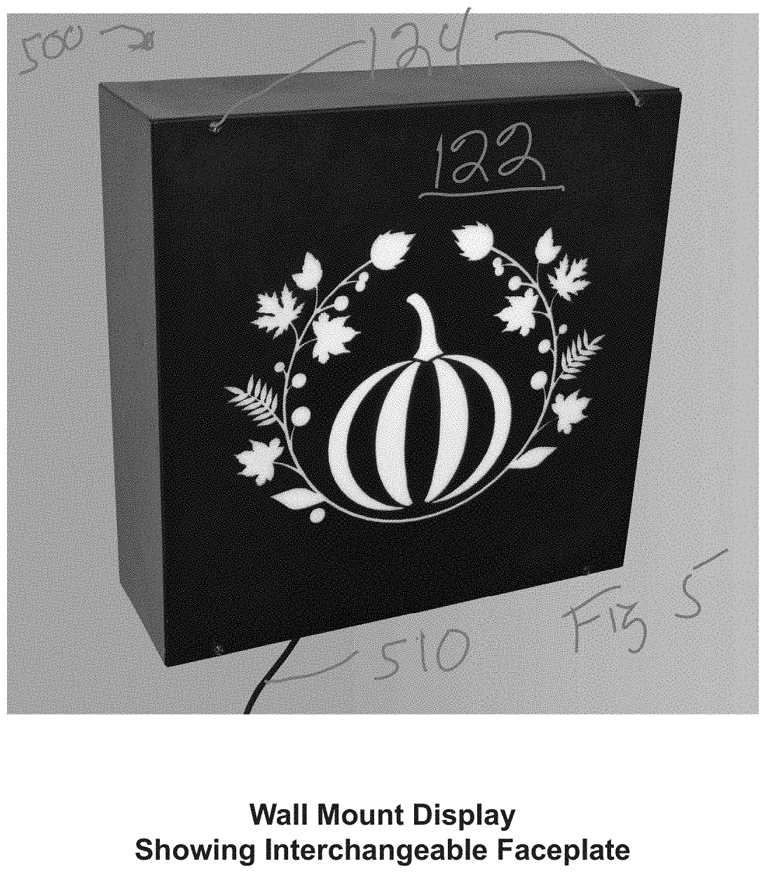

Now referring to FIG. 5, there is shown a wall mount display system 500 of the present invention which includes an interchangeable faceplate 122 which could be identical in function to faceplate 122 of FIGS. 1 and 4 or as shown here with a different decorative image. Screws 124 are shown after having been advanced into and through holes 424 (FIG. 4) and into screw receiving holes 224 of FIG. 2. A power cord 510 is shown, but could be replace with an internal battery assembly a power cord if desired.

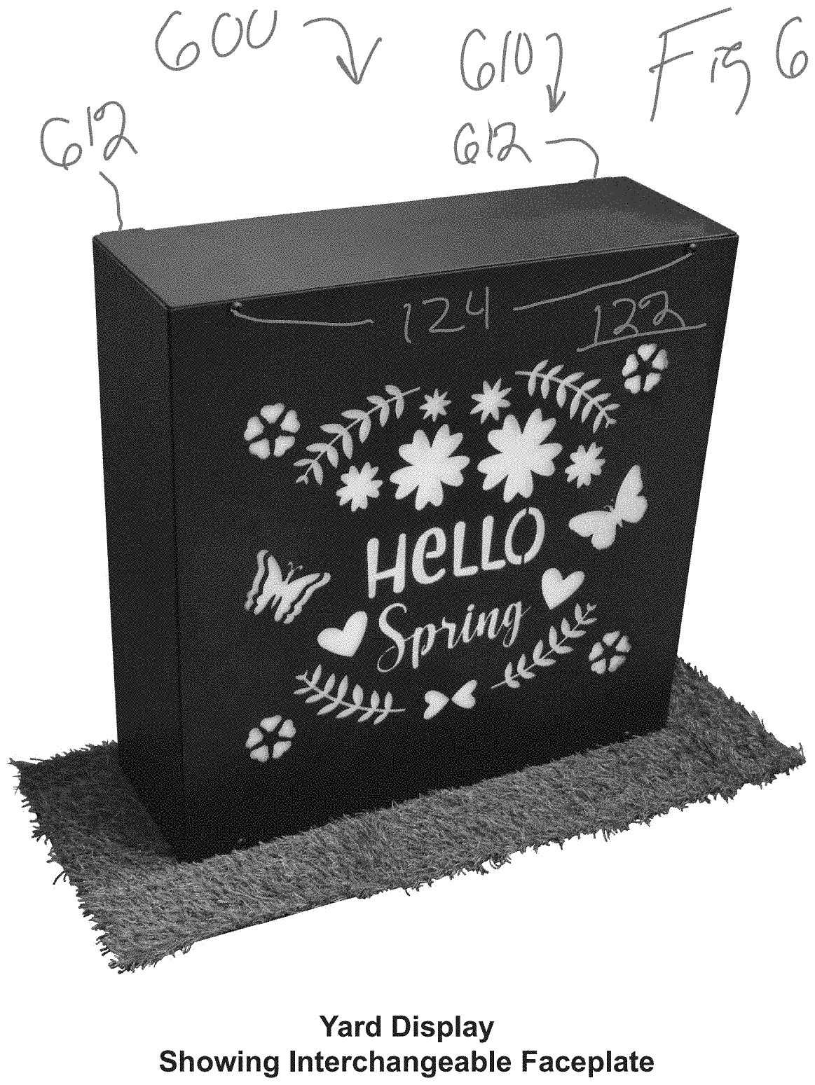

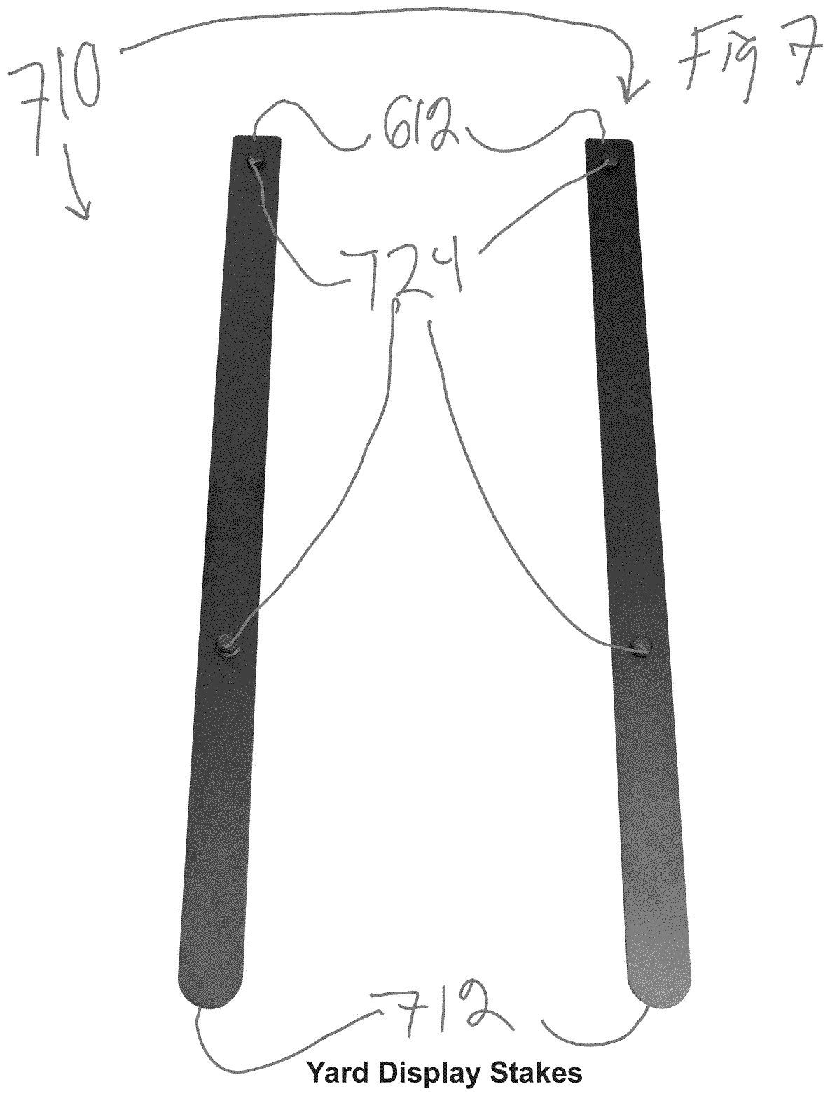

Now referring to FIGS. 6 and 7, there is shown portions of a yard display 600. The yard display 600 may be very similar to the wall mount display system 500 of FIG. 5, except for the addition of yard stake 710 (FIG. 7) which have top portions 612 visible at the top 610. Yard stakes 710 are shown with bolts 724 for attaching the yard stakes 710 to display 600. The yard stakes 710 are each shown with a curved portion for insertion into the ground or other substrate.

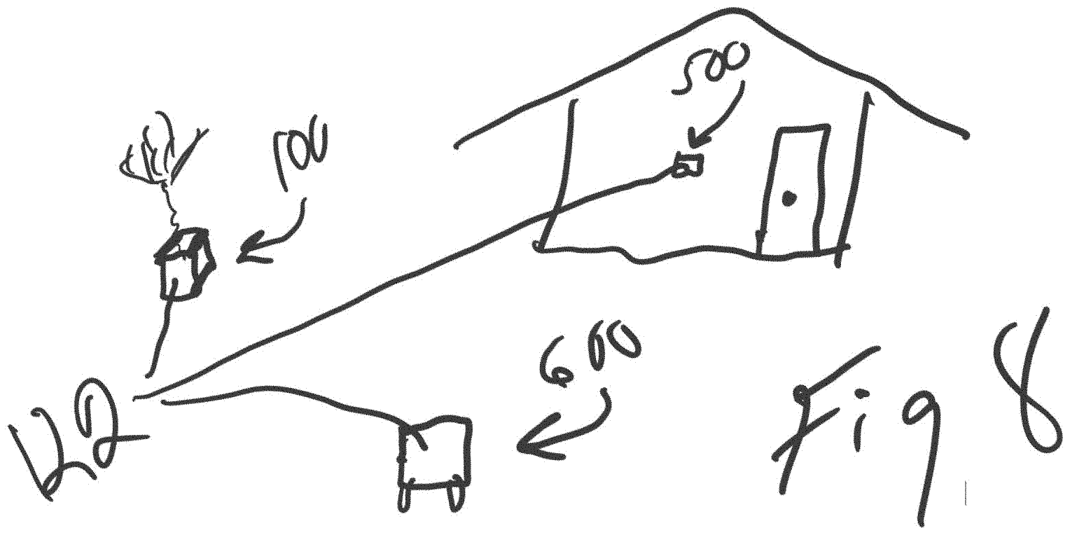

Now referring to FIG. 8, there is shown a system of the present inventions where it show an identical faceplate 122 with each of the planter box 100, the wall mount display system 500, and the yard display 600 in one location.

The systems of FIGS. 1-8 could be made with steel with a thickness of 14 gauge, approximately 0.0747 of an inch thick. It is commercial grade carbon steel. Steel used to make the faceplates are produced in steel mills. Steel mills produce ingots of steel. These ingots are then run through a series of rollers that make the ingots longer and thinner. The more rolls the steel goes through the thinner the steel. The steel mill makes a coil of steel. These large coils of steel are sold to steel service centers. Steel service centers then unroll the coil and cut the material to the desired widths and lengths of steel needed by the customer. They basically unroll the coil, level it and cut to customer's needs. In a preferred manner this material could be in 60″×120″ sheet which then can be processed through a plasma or laser steel cutter.

For all the steel surfaces, We are using a powder coating paint process. You start with a powdered paint that is deposited on the metal with an electrostatic spray. The item is then placed into a curing oven of approximately 400-degree Fahrenheit. The plastic paint melts together and bonds to the steel surfaces.

It is thought that the method and apparatus of the present invention will be understood from the foregoing description and that it will be apparent that various changes may be made in the form, construct steps and arrangement of the parts and steps thereof without departing from the spirit and scope of the invention or sacrificing all of their material advantages. The form herein described is merely a preferred exemplary embodiment thereof.

We claim:

1. A system comprising:
A planter box having a first backlighted laser cut powder coated steel faceplate, with a first portion of steel having been removed therefrom;
A wall mounted display having a second backlighted laser cut powder coated steel faceplate, with a second portion of steel having been removed therefrom;
A yard display having a third backlighted laser cut powder coated steel faceplate with a third portion of steel having been removed therefrom;
said first backlighted laser cut powder coated steel faceplate, said second backlighted laser cut powder coated steel faceplate, and said third backlighted laser cut powder coated steel faceplate are each configured so as to be interchangeable with each other; and,
each of said first portion, said second portion, and said third portion being individually and identically defined by a common data file.

2. A method of displaying information from a system including a planter box, a wall mounted display and a yard display supported by yard stakes;
the method comprising the steps of:
providing a planter box having a first backlighted laser cut powder coated steel faceplate, with a first portion of steel having been removed therefrom;
providing a wall mounted display having a second backlighted laser cut powder coated steel faceplate, with a second portion of steel having been removed therefrom;
providing a yard display having a third backlighted laser cut powder coated steel faceplate with a third portion of steel having been removed therefrom;
said first backlighted laser cut powder coated steel faceplate, said second backlighted laser cut powder coated steel faceplate, and said third backlighted laser cut powder coated steel faceplate are each configured so as to be interchangeable with each other; and,
defining each of said first portion, said second portion, and said third portion by utilizing a common data file.

3. A system comprising:
A planter box having a first backlighted laser cut powder coated steel faceplate, with a first portion of steel having been removed therefrom;
A wall mounted display having a second backlighted laser cut powder coated steel faceplate, with a second portion of steel having been removed therefrom;
A yard display having a third backlighted laser cut powder coated steel faceplate with a third portion of steel having been removed therefrom;
said first backlighted laser cut powder coated steel faceplate, said second backlighted laser cut powder coated steel faceplate, and said third backlighted laser cut powder coated steel faceplate are each configured so as to be interchangeable with each other; and,
each of said first portion, said second portion, and said third portion being defined by a data file.

4. The system of claim 3 wherein each of said first portion, said second portion, and said third portion being individually defined by a unique data file.

5. The system of claim 3 wherein each of said first portion, said second portion, and said third portion being defined by a common data file.

6. The system of claim 3 wherein said data file is common data file used to define each of said first portion, said second portion, and said third portion.

7. The system of claim 6 wherein said common data file is a NC files used in controlling a CNC laser cutter.

8. The system of claim 7 wherein said planter box, wall mounted display, and yard display each further comprise a battery assembly which includes a battery, a wireless communication system and a control system.

9. The system of claim 8 where said wireless communication system and said control system are configured to enable simultaneous and/or synchronized turning on and off of the backlight.

10. The method of claim 2 further comprising the steps of:
Turning on and off in unison the backlight in each of the planter box, the wall mounted display and the yard display.
